(19) United States
(12) Patent Application Publication
(10) Pub. No.: US 2006/0226953 A1
(43) Pub. Date: Oct. 12, 2006

(54) Passive entry sensor system

(75) Inventors: Michael J. Shelley, West Lothian (GB); Alex Crawford, East Kilbride (GB); Pascal Schweizer, Saint Martin D'Uriage (FR); Adrian Kettle, Swindon (GB); Marek Gierczak, Meylan (FR)

Correspondence Address: Kris T. Fredrick;Honeywell International Inc., 101 Columbia Rd., P.O. Box 2245, Morristown, NJ, 07962, US

(73) Assignee: Honeywell International Inc.

(21) Appl. No.: 11/156,670

(22) Filed: Jun. 17, 2005

Related U.S. Application Data
(60) Provisional application No. 60/669,326, filed on Apr. 7, 2005.

(51) Int. Cl. G05B 19/00

(52) U.S. Cl. 340/5.62; 340/5.72

(57) ABSTRACT

Passive entry sensor systems and associated sensors are disclosed. The system sensor is arranged in the handle of a door or directly mounted to the door skin. When mounted in the handle, the sensor provides an electromagnetic radiation beam transmitted either along the length of the handle between opposite ends thereof or between the handle and the door so that the beam can be at least partially interrupted or modified by a user actuating the handle. When mounted directly to the door skin, the sensor provides an electromagnetic radiation beam transmitted between the handle and the door. The sensor system includes indicators for indicating system status to the user, back-up switches for detecting a pull on the handle, locking switches for activation by a user to lock or unlock the door and backlight and ground light lighting.

### CROSS-REFERENCE TO PROVISIONAL PATENT APPLICATION

This patent application claims priority under 35 U.S.C. § 119(e) to provisional patent application Ser. No. 60/669,326 entitled “Passive Entry Sensor System,” which was filed on Apr. 7, 2005, the disclosure of which is incorporated herein by reference.

### TECHNICAL FIELD

Embodiments are generally related to sensing devices and applications. More particularly, embodiments are related to sensor devices and systems for use in keyless access systems which operate passively to enable access by an authorized user to secured environments. Embodiments are additionally related to multi-functional passive entry sensors and systems. Embodiments are also related to passive entry sensors and system configurations utilized in automotive applications.

### BACKGROUND OF THE INVENTION

It is important, for many reasons, to control access to premises, vehicles and personal property so that only authorized users are allowed access. Typically this is done using keys which fit a lock to allow the user of the key to open the lock and gain entry. One problem with the existing key and lock arrangements is that loss or damage to the key can render access impossible. In addition, if the key lock itself is blocked or damaged this can also prevent access. One other problem is that the use of a key requires a specific action such as unlocking a latch with the key from the authorized person before an action of opening the door. This specific action is very often not easy to do, not ergonomic and is time-consuming.

A number of ways have been proposed to try to overcome these disadvantages. With security devices for cars, it is well known that a keyless fob can be used, such that actuation of a button on the fob generates an infrared (IR) or radio frequency (RF) signal which is detected by a sensor in the vehicle which unlocks the doors. A key is still required by the user in order to operate the ignition system. The fob also contains a lock button which generates a similar IR or RF signal to lock the vehicle. Such vehicle keyless access systems have been known for a number of years. Such systems operate on the basis that when the IR or RF “open” signal is generated by the fob, the signal is used to actuate a mechanism which unlocks the car door so that when the user pulls on the handle, the door is already unlocked. Similar arrangements may be used for building entry.

One problem with this arrangement is that the user still has to initiate a specific action such as, in the case of a fob, taking the fob in his hand and pressing on the fob button, or in the case of a magnetic card or the like, inserting the card in a slot or to present it in front of a card reader/detector or the like, in order to unlock the door and have access to the vehicle, these specific actions being time-consuming and not ergonomic.

One other problem with this arrangement is that if the user decides not to enter the vehicle but forgets to actuate the “lock” signal, the car and/or building remains open and is thus vulnerable. In addition, with existing keyless locking systems, particularly for vehicles, a conventional locking mechanism is used which is susceptible to interference by thieves to gain access to the car. For buildings, conventional locks are actuated in the same way and are susceptible to the same procedures by intruders to gain access to the premises.

A passive entry sensor system for use in a keyless access system used in automotive applications transmits a beam of light from a sensor that is bracket-mounted and located behind the door skin. The beam of light strikes a lens protector mounted on the door skin, where the beam is deflected towards a mirror mounted on the door handle. On striking the mirror, the beam is reflected back to the lens protector where it is deflected into the sensor and detected. Alternatively, the bracket-mounted sensor can be configured to provide a beam from one end of the handle to the other by optically coupling the bracket-mounted sensor to the handle.

Such passive entry sensor systems are expensive to implement, particularly in automotive applications, as a result of high piece part count and assembly time. Furthermore, in order to use such a system, extensive modification of the door skin of the vehicle is necessary. Also, the functionality of such sensors is limited.

There is a need to provide a more cost effective passive entry sensor system. There is also a need to provide a passive entry sensor system with increased functionality. Additionally, more efficient passive entry sensors and systems are necessary which can be used to open doors, access panels or the like in a range of applications.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved sensor devices and applications.

It is another aspect of the present invention to provide for improved passive entry sensors and systems.

It is a further aspect of the present invention to provide for multi-functional passive entry sensors and systems.

It is an additional aspect of the present invention to provide for an improved passive entry sensor and system which can be utilized with an access control system for allowing access to a vehicle.

The aforementioned aspects of the invention and other objectives and advantages can now be achieved as described herein. Passive entry sensor systems comprising sensors mounted to handles of doors or the like or to the door skin are disclosed.

The sensors comprise an electromagnetic radiation emitter for transmitting a beam of electromagnetic radiation and an electromagnetic radiation detector for detecting the electromagnetic radiation beam. The emitter and detector are arranged such that the sensor can detect at least a partial interruption or modification of the beam caused by a user actuating the handle of the door.

When handle mounted, the sensor can be arranged to provide an electromagnetic radiation beam transmitted either along the length of the handle between opposite ends thereof or between the handle and the door so that the beam can be at least partially interrupted or modified by a user actuating the handle by inserting the user's hand between the handle and the door or by other means such as by swiping a card or the like through a slot. Mounting the sensor to the handle rather than behind the door skin avoids the need to use a bracket to mount the sensor or to use light pipes to optically couple the sensor to the handle. Another advantage of this arrangement is that it is not necessary to punch an aperture in the door skin so that the beam can be transmitted and detected. Consequently, this arrangement simplifies construction of the passive entry sensor system in the door handle assembly.

The passive entry sensor system can include a beam reflector for reflecting the emitted beam back to the detector. When the sensor is mounted in the handle and arranged to provide the beam along the length of the handle between opposite ends of the handle, the sensor can be disposed at or adjacent one end of the handle and the reflector located at or adjacent the opposite end of handle for reflecting the emitted beam back to sensor at the other end of the handle. Alternatively, when the sensor is mounted in the handle for providing an emitted beam between the handle and the door, the reflector can be located on the door beneath the handle for reflecting the beam back to the sensor in the handle.

When the sensor is mounted directly to the door skin, the sensor provides an electromagnetic radiation beam transmitted between the handle and the door. The sensor includes a lens protector for protecting the emitter and detector. By incorporating the lens protector in the sensor and mounting the sensor directly to the door skin, the additional bracket for mounting the sensor to the door is avoided. The sensor can include a clip or latch for retaining the sensor directly in an aperture defined in the door skin which arrangement is particularly advantageous in that the sensor can be retained to the skin by itself without any additional fixing means. The reflector can be located on the back side of the handle for reflecting the beam back to the sensor on the door. Alternatively, the sensor can be clipped to an aperture formed in the skin of the handle and the sensor can transmit a beam to the door and detect the beam reflected from the door.

The sensor may include a signal processor coupled to said emitter and detector for detecting at least a partial modification or interruption of the beam and for providing an output control signal in response thereto to an access control mechanism, such as a KACM, for controlling the operation of a door locking device.

The passive entry sensor system may be provided with additional functionality by including a back-up switch, an independent locking switch, at least one indicator, a backlight, a ground light, an antenna, a closed circuit digital (ccd) camera for parking help, and/or a distance measurer for safety purposes.

The back-up switch can be included in the sensor and coupled to the signal processor so that the processor can provide an output control signal to the access control mechanism in the event that the user's hand actuating the handle is not detected by the sensor system for some reason. The independent locking switch can be mounted to the handle for providing an output control signal to lock or unlock the door when the user actuates the locking switch. Light sources, such as light emitting diodes (LEDs), can be located in the sensor and/or in the handle separately from said sensor and can be optically coupled to corresponding light pipes, windows or other optical elements located in apertures of the handle for indicating one or more system modes such as alarm activated, right-left turn vehicle indication, locked or unlocked door status, and for providing back or ground lighting. The light sources and sensor can be contained in a single plug-in unit which can be inserted into the handle for rapid assembly of the system.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a front perspective view of a vehicle door assembly incorporating a passive entry sensor system which is implemented in accordance with a first embodiment;

FIG. 2 illustrates a rear perspective view of the door handle shown in FIG. 1;

FIG. 3 illustrates an exploded view of the end of the inner handle incorporating the sensor shown in FIG. 2;

FIG. 4 illustrates a sectional view taken longitudinally through the inner handle end shown in FIG. 3;

FIG. 5 illustrates an exploded view of the central portion of the inner handle;

FIG. 6 illustrates a block diagram of the circuit used in the passive entry sensor system for interfacing with a control module of a vehicle;

FIG. 7 illustrates a perspective view of a passive entry sensor system arranged in a door assembly according to a second embodiment;

FIGS. 8a and 8b respectively illustrate front and side perspective views of the handle shown in FIG. 7;

FIGS. 9a and 9b respectively illustrate front and rear exploded views of the plug-in unit shown in the handle of FIG. 8a;

FIG. 10 illustrates an exploded view of a passive entry sensor system arranged in a door assembly according to a third embodiment;

FIG. 11 illustrates a passive entry sensor system arranged in a door assembly according to a fourth embodiment;

FIG. 12 illustrates an exploded view of the door assembly shown in FIG. 11;

FIGS. 13a and 13b respectively illustrate front and rear perspective views of the optical sensor used in the system shown in FIG. 11; and

FIGS. 14a and 14b respectively illustrate front and rear exploded views of the optical sensor used in the system shown in shown in FIG. 12.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

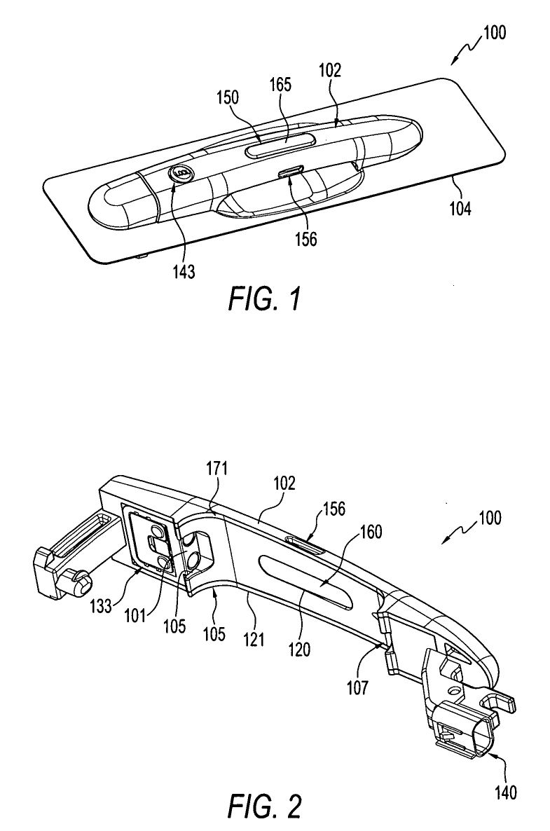

FIGS. 1 and 2 of the accompanying drawings respectively illustrate front and rear perspective views of the passive entry sensor system 100 arranged in a vehicle door handle assembly 102 according to a preferred embodiment. As best shown in FIG. 2, the sensor system includes an optical sensor 101 mounted directly in an end of a door handle assembly 102 and a reflector 107, such as a mirror or a flat painted area, located at an opposing end of the handle facing the sensor. The optical sensor 101 is adapted to transmit an IR beam 120 at an angle along the length of the handle to the reflector 107 and to detect the IR beam 121 reflected back by the reflector. When the handle is mounted on the door skin 104, as shown in FIG. 1, the transmitted beam can be interrupted or modified by a user inserting his hand between the opposing ends of the handle to actuate the door handle.

As will be described in more detail below, the sensor 101 includes signal processor circuitry which detects the interruption or modification of the beam 120,121 and, anticipating a pull of the door, provides an output control signal to a control module which generates an RF signal for interrogating a user's digital ID on a card. When satisfactory response is obtained, i.e. the user's head ID matches a stored digital ID; a control signal is generated by a processor in the control module to unlock a locking mechanism and allows the door to open.

The handle 102 comprises an inner handle 105 with a handle skin 171 disposed thereon. The inner handle includes an indicator module 150 mounted centrally in the handle and a plug-in connector 140, integrally formed in the end of the handle opposite the end incorporating the sensor 101, for connecting the circuitry of the sensor 101 and indicator module 150 to the vehicle. As will be described in more detail below, the indicator module 150 is adapted to indicate different systems modes to a user approaching the vehicle and to provide back and ground lighting.

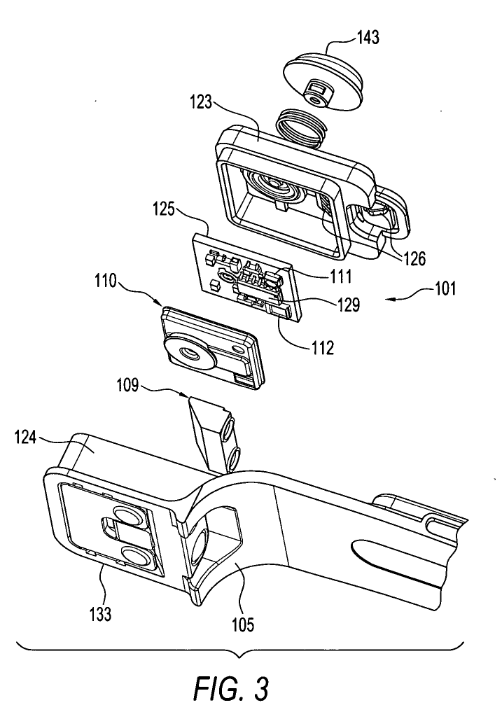

As best shown in FIG. 3, which illustrates an exploded view of the end of the inner handle 105 incorporating the optical sensor 101, a cover 123 cooperates with a component receiving portion 124 formed in the inner handle end to form an optical enclosure for the sensor. A printed circuit board (PCB) assembly 125 is disposed in the optical enclosure between an electromagnetic shield 110 and the cover 123 and is electrically coupled to external circuitry in the remainder of the inner handle by spring contact terminals 126. The contact terminals 126 make contact with contact pads located on the front of the PCB 125 and on the front of the inner handle 105 on the exterior of the optical enclosure. An IR LED 111 and detector 112 for transmitting and detecting the beams 120,121, respectively, are surface mounted on the underside of the PCB 125 and are optically coupled to a light filter 109, seated beneath the shield 110, which includes a pair of insert molded lenses for directing the transmitted beam 120 towards the reflector 107 and for directing the reflected beam 121 back into the sensor. The detector may be an IR photo-transistor or other appropriate photo-detector. The detector is integrated in an application specific integrated circuit (ASIC) chip. The emitter may also be integrated in such a chip. A signal processor 129 mounted on the PCB 125 is electrically coupled to the IR LED 111 and the photo-detector 112 and is configured to detect an interruption of the beam and provide an output control signal to the control module to enable the control module to verify the identity of the user and accordingly unlock the door.

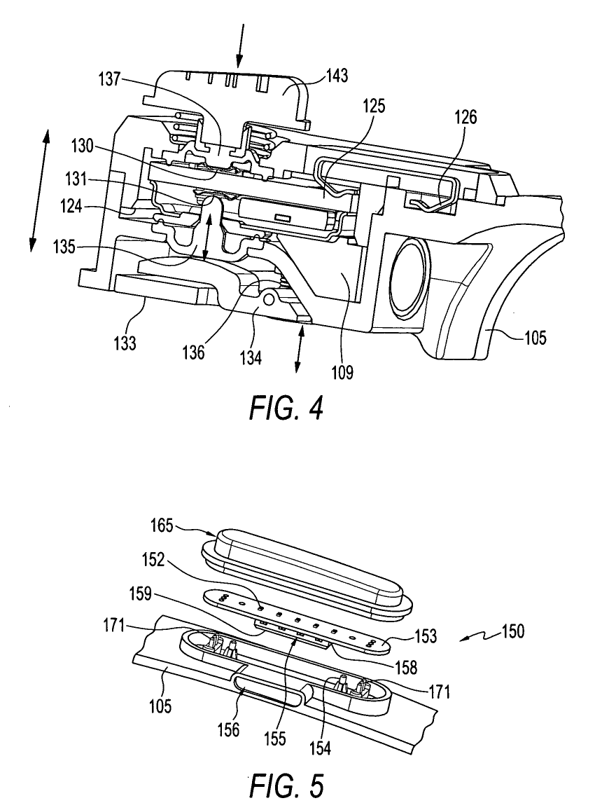

Referring to FIG. 4, which illustrates a sectional view taken longitudinally through the end of the inner handle, an actuator, 133,134,136, mechanical plunger 135, and mircoswitch 131 are also located in the handle end and serve as a back-up switch which allows the user to unlock or open the door in the event that the optical sensor fails to detect an interruption or modification of the beam for some reason when the user actuates the door handle 102. The signal from the activated microswitch 131 replaces the signal from the sensor and is dealt with by the general processor of the vehicle in the same way to allow unlocking or locking of the door.

The microswitch 131 is operable by the actuator via the mechanical plunger 135 seated in an aperture defined in a bottom wall of the component receiving portion 124. The plunger 135 is provided with an over molded seal to ensure the optical enclosure of the sensor is preserved. The actuator comprises a U-shaped primary flap 133 with the free arms disposed beneath respective coil springs 137 and a secondary flap 134, pivotally mounted between the free arms, which is shaped to overlap the upper surface of the body of the flap 133 and rest beneath the plunger 135. Configuring the flaps 133,134 in this manner allows the secondary flap 134 to immediately move the plunger 135 upwardly to operate the micro switch 131 as soon as the primary flap 133 is provided with limited movement by the coil spring and therefore increases the sensitivity of the actuator to handle motion.

Also mounted in the handle end are a transparent button 143, a snap button 137 and a microswitch 130, which together serve as a locking switch to allow the user to unlock or lock the door by the user manually activating the button 143 on the handle as desired. The snap button 137 carries the button 143 and is mounted on a transparent flexible seal molded over an aperture formed in the front of the cover. The microswitch 130 is operable via the snap button by depression of the button 143 to provide a signal which is dealt with by the general processor of the vehicle to allow unlocking or locking of the door. Indicator LEDs (not shown) are also mounted on the PCB for illuminating the button 143 when a user is approaching the vehicle to indicate to the user one or more system modes, such as alarm activated or normal mode.

Reference will now be made to FIG. 5, which illustrates an exploded view of the central portion of the inner handle 105 incorporating the indicator module 150. An indicator lens 155 cooperates with a recess 154 extending along the longitudinal axis of the inner handle to form an optical enclosure and is designed to protrude through a complimentary front aperture defined in the handle skin 170. A PCB 153, retained in the recess, is electrically coupled to the PCB 125 and the connector 140 via an electrical connection fretwork 171 at opposite ends of the recess.

A plurality of multi-colored indicator LEDs 152, surface mounted on the PCB 153, is directed towards the indicator lens and, like the indicator LEDs mounted in the sensor, can be selectively activated by a control module in the vehicle to indicate to the user the current system mode. In this particular embodiment, blue LEDs are used to indicate normal mode, green and red LEDs indicate unlocked and locked door status, respectively, and amber LEDs indicate left/right turn indication. Also, red LEDs can be activated intermittently by the control module to indicate the alarm is set.

A light pipe 156 mounted in a passageway integrally formed in a side of the inner handle and communicating with the recess 154 allows the transmission of light out of the handle from side directing LEDs 155 mounted underneath the PCB 153 to provide a ground light. A lens 160 is received in a rear aperture of the handle for allowing transmission of light from rear directing LEDs 158 provided underneath the PCB to provide a backlight (See FIG. 2). The LEDs 155,158 can be activated by the control module to provide back and ground lighting when a user approaches the vehicle. As shown in FIG. 5, the indicator module 150 also includes an antenna mounted on the underside of the PCB for receiving an RF signal. Incorporating the locking switch, indicators, antenna and back and ground lights into the handle together with the senor, provides a multi-functional passive entry sensor system which is compact and robust. Additional functionality can be provided by incorporating in the handle a CCD camera for adding in parking and an optical or ultrasonic distance measurer for safety purposes.

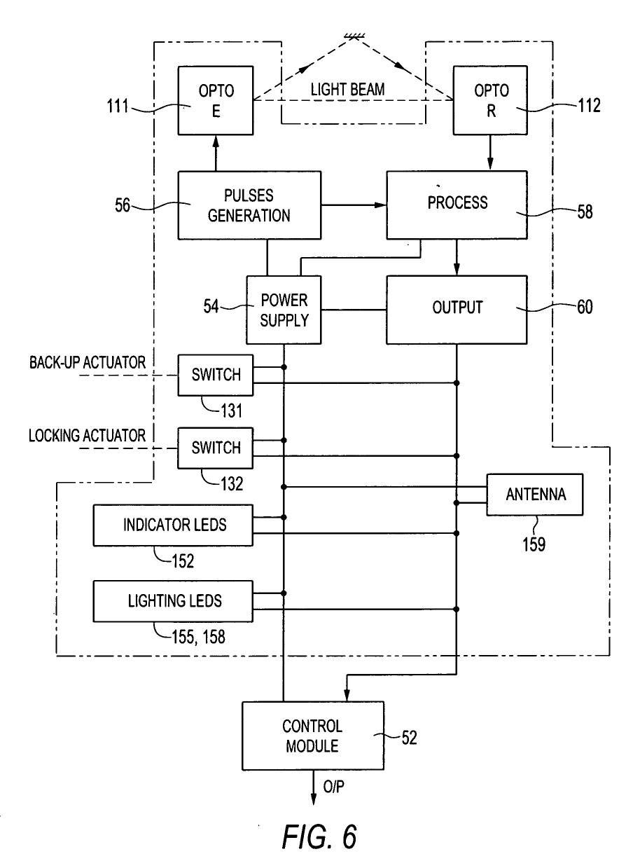

Reference will now be made to FIG. 6 which illustrates a block diagram of the circuit used in the passive entry sensor system 100 for interfacing with a control module of the vehicle. The circuit is coupled to current power supply 54 which supplies power to the main circuit components; pulse generator circuitry 56; signal processing circuit 58 including the signal processor, for processing the output from the photo-detector 121, output circuit 60 for providing an output control signal to the control module 52, microswitches 130,131, indicator and back and ground light LEDs 152, 155,158 and the antenna 159. The control module can activate the indicator and back and ground light LEDs as required. In this case, the circuit is arranged so that the IR LED 111 provides a pulsed beam and the processor detects the presence or absence of a predetermined number of pulses.

A pulse generator 56 generates pulses at a rate of 1 KHz and the frequency signal is fed to the IR LED 111 and to the signal processing circuitry 58 to synchronize detection of signals by the photo-detector 112. As long as both sets of pulses are received, a counter in the processing circuitry 58 is continually reset to zero and the output circuitry 60 does not generate an output signal. When the light beam 120, 121 is interrupted such that a predetermined number of light pulses are not received by the photo-detector, the signal processing circuitry 58 detects this and actuates the output circuitry 60 to generate an output signal to the control module 52.

Details concerning the circuitry used to generate the pulsed IR signal, for detecting the reflected signals and also for detecting when the reflected signal is interrupted are disclosed in US Patent Publication No. US2004/0031908 which is incorporated herein by reference. Alternatively, the circuit can be arranged so that the IR LED 111 provides a continuous beam and the processor detects the absence of the continuous beam at the photo-detector 112 for a predetermined period.

The method of operating the passive entry system arranged in a door handle of a vehicle according to the first embodiment will now be described with reference to FIGS. 1, 2, 5 and 6. Initially the vehicle door is locked and as the user begins to approach the vehicle, the control module 52, in response to a signal from an activity sensor, activates the back and ground light LEDs 158, 155, in the handle 102 to illuminate the ground and the door panel beneath the handle. The control module selectively activates the indicator LEDs 152 so that the handle locking button 143 and indicator lens 165 are illuminated red indicating to the user that the door is locked. When the user initially inserts his hand between the handle 102 and the door skin 105 to open the door, the beam is interrupted.

The signal processor circuitry 58 detects this interruption and interprets this as an authorized user wishing to open the door. The processor transmits a control signal to the control module 52 which then generates an RF signal for interrogating the user's digital ID on a card. A response from the user is received by the antenna 159 in the indicator module and provided to the control module. If a suitable response is received confirming the ID of a user, the control module 52 sends a signal to unlock the door. This response time is typically 3.0 to 3.5 milliseconds (MS) and by the time the user pulls the door handle, the door is already unlocked.

Unlocking the door causes the control module to selectively activate indicator LEDs 152 so that the locking button 143 and indicator lens 165 on the handle are illuminated green indicating to the user that the door is unlocked. When the user desires to lock the door, the user depresses the locking button 143 on the handle 102 which triggers the microswitch 131 and generates an output control signal to the control module 52 which then locks the door. As a result, the control module once again selectively activates the indicator LEDs 152 so that the indicator lens 165 and locking button 143 are illuminated red indicating to the user that the door is locked. If the vehicle alarm has been activated, the control module 52 selectively activates the indicator LEDs 152 associated with the locking button intermittently indicating to the user that the vehicle alarm is set.

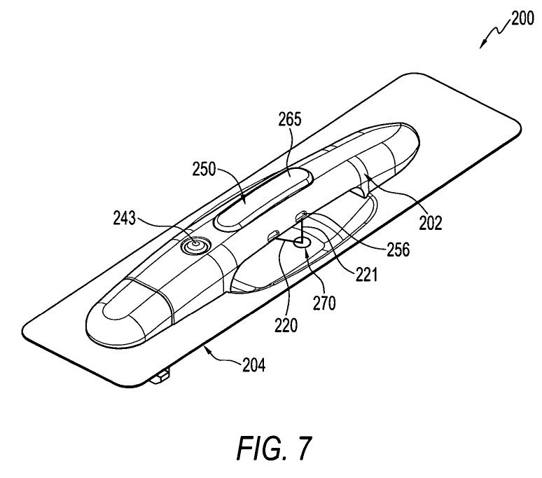

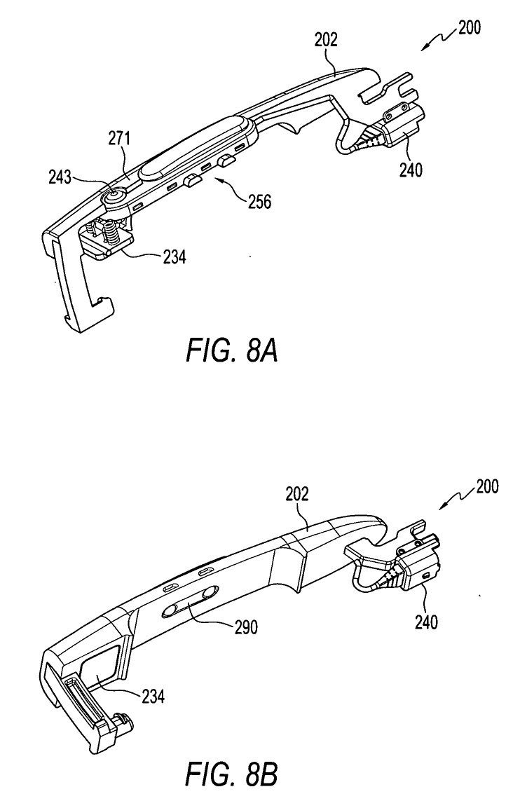

Reference will now be made to FIGS. 7, 8a and 8b, which illustrate various perspective views of a passive entry sensor system 200 arranged in a door handle according to a second embodiment. As will be described in more detail below, in this embodiment, the optical sensor 201 and indicator module 250 are combined together in a single plug-in unit 271 (shown in broken line in FIG. 8a) arranged about the centre of the handle such that the optical sensor can emit the beam 220 through the rear aperture of the handle 202 at an angle towards the door and detect the beam reflected by the reflector located on the door beneath the handle. The plug-in unit 271 is connected via a wire harness 260 to the connector 240 which connector can be left floating or insert molded into the end of the handle. Combining the indicator module and optical sensor in the plug-in unit 271 facilitates easy and rapid assembly of the sensor and indicator module in the handle without substantial modification of the handle.

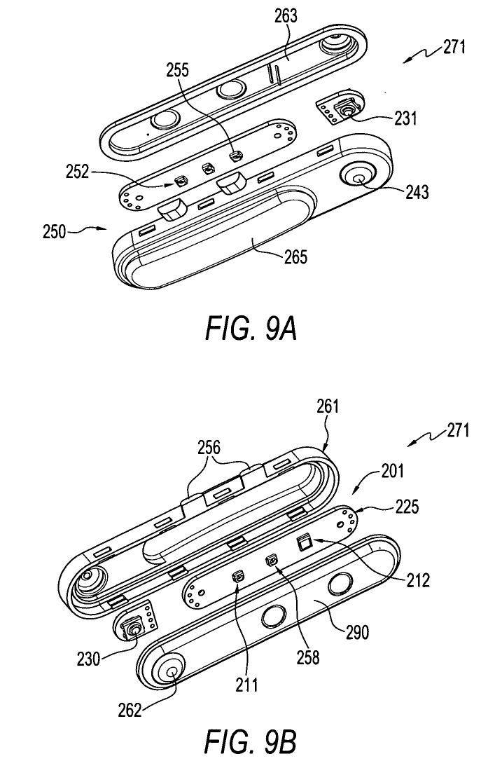

Referring to FIGS. 9a and 9b, which, respectively, illustrate front and rear exploded views of the plug-in unit 271 shown in FIG. 8a, this is shown polycarbonate upper and lower casings 261, 263 which cooperate to form the optical enclosure. The IR LED 211, photo-detector 212 and backlight LED 258, mounted on the rear of the PCB 225, face entry optics integrated in the lower casing 263 which optics serve as lenses for the beams 220,221 and backing lighting passing through the rear aperture of the door handle. An indicator window 265, integrally formed in the upper casing 261, for insertion into the front aperture of the handle, permits the passage of light from the indicator LEDs 252 mounted on the front of the PCB 225. Lights pipes 256, integrally formed in the upper casing, protrude from the casing for insertion into side apertures of the handle for allowing the passage of light from the ground lighting LEDs 255. A back-up button 262, for actuation by the back-up actuator 234 housed in the handle end, and a locking button 243 is integrally formed in the lower and upper casings, respectively, and operate the microswitches 230,231. As shown in FIG. 7, the locking button 243 and indicator window 265 are exposed on the front of the handle and can be illuminated in a similar manner to the locking button and window in the first embodiment.

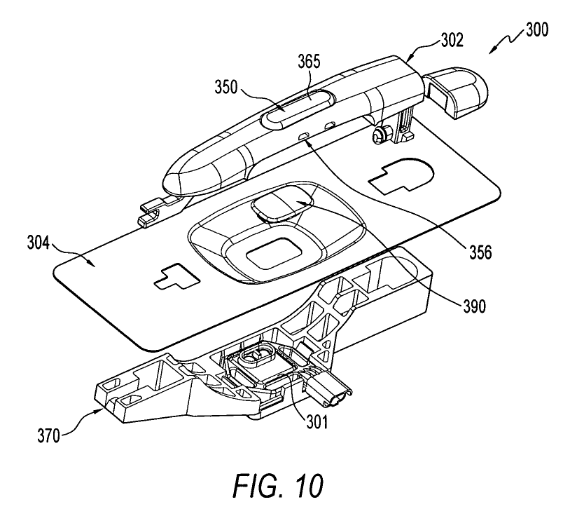

Another embodiment of the passive entry system arranged in a door handle assembly is illustrated in exploded view in FIG. 10. In this third embodiment, the optical enclosure of the sensor 301 is mounted in a bracket 370 which is fixed underneath the door skin 304 with the indicator module 350 remaining incorporated into the handle 302. A transparent polycarbonate molding with a front indicator window 365 and rear reflective area is located in a through aperture in the centre of the handle and serves as the optical enclosure of the indicator module.

The door skin 304 defines an aperture 380 which receives a lens protector assembly 390 through which the emitted beam is transmitted to the reflector (not shown) which is located on the underside of the handle 302. The beam is reflected back from the handle to the sensor. The indicator and back and ground light LEDs are operable by the control module in the same manner as those used in the first and second embodiments. Apertures for receiving the ground light pipes 356 are received in a pair of side apertures of the handle

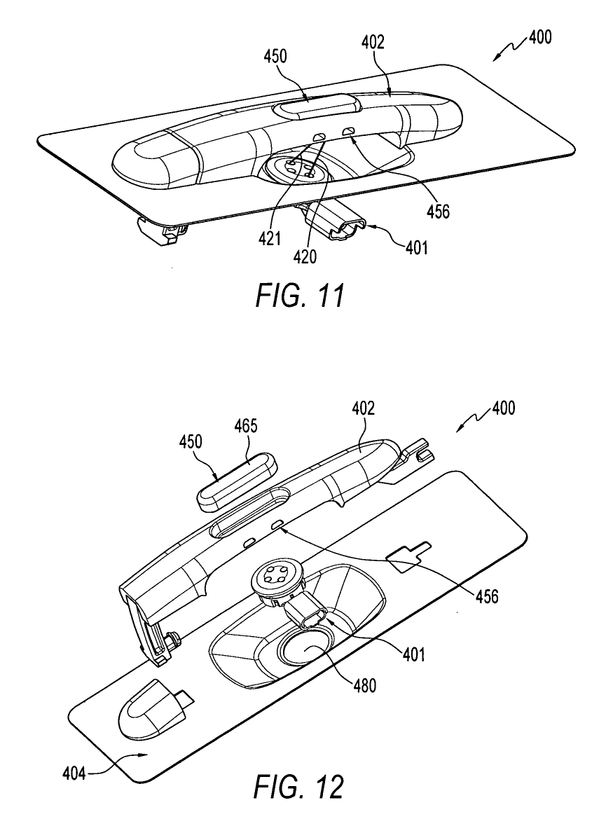

Reference will now be made to FIGS. 11 & 12, which, respectively, illustrate perspective and exploded views of a passive entry systems 400 arranged in the door handle assembly according to a fourth embodiment. In this embodiment, the optical sensor 401 is adapted to be mounted directly in an aperture 480 of the door skin 404. The sensor transmits the beam 420 towards the handle where the beam is reflected on the underside of the handle as in the case of the third embodiment. Also, the indicator module 450 and side light pipes 456 are arranged in the handle in the same manner as the indicator and side light pipes of the third embodiment. This embodiment has the advantage that a bracket, such as that shown in FIG. 11, also need not be used to mount the sensor to the door skin. Furthermore, additionally functionality is provided.

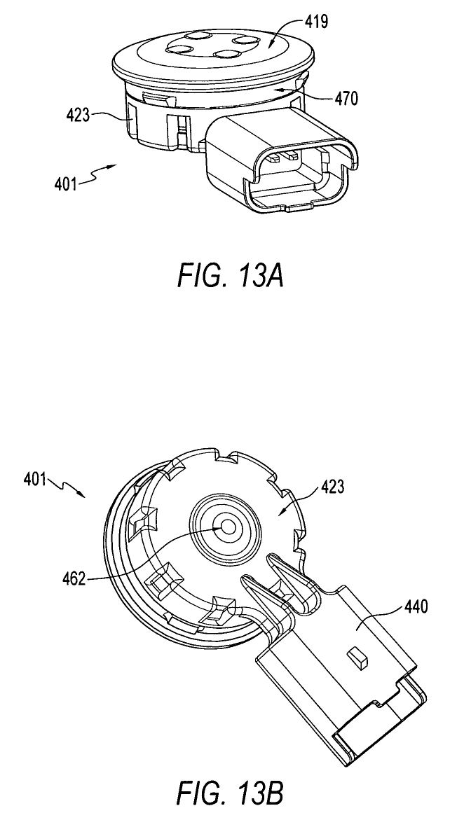

Referring to FIGS. 13a and 13b, which, respectively, illustrate perspective views of the front and rear of the optical sensor 401 shown in FIG. 11, there is shown a sensor housing assembly, formed by a cover 423 cooperating with an optical lens assembly 419, and a snap ring 470 carried on the housing for retaining the sensor 401 in the door aperture 480. In this embodiment, a back-up button 462 and the connector 440 of the sensor are molded to the cover.

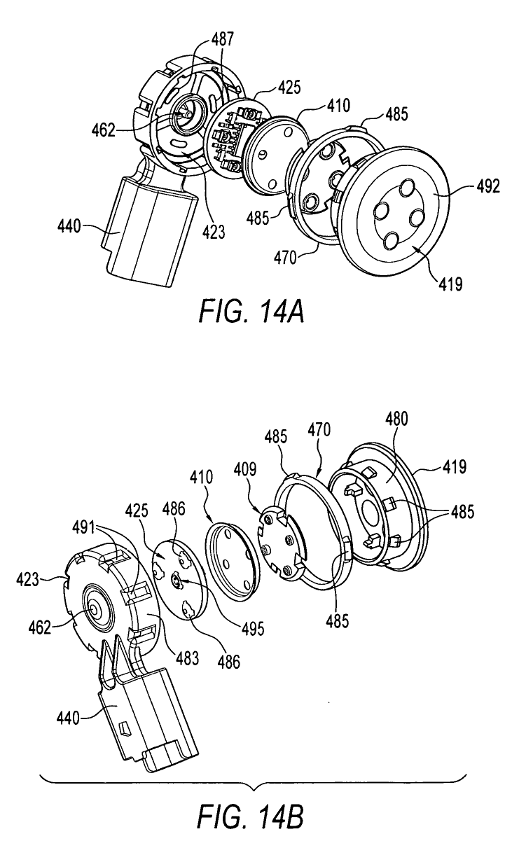

As can be seen from FIGS. 14a and 14b, which illustrate exploded views of the sensor 401 shown in FIG. 11, the sensor includes a PCB assembly 425 including the IR LED and photo-detector mounted thereon, the electromagnetic shield 410 and optical filter 409. Dome contacts 486, surface mounted on the PCB assembly 425, contact corresponding electrical connection contacts 487 insert molded in the bottom of the cover 423 for connecting the PCB to the connector 440. A dome switch 495, mounted on the PCB, is operable via the back-up button 462 to provide the back up signal to the output control module. The back-up button can be activated by a back-up actuator below the door skin. The optical lens assembly 419 incorporates the lenses and a lens protector and directs the beams 420,421 into and out of the sensor.

Openings in the filter 409 and shield allow the passage of light from the multi-colored indicator LEDs, surface mounted on the PCB, out of the front of the lens assembly to indicate system modes below the handle. This is advantageous in that system mode indication can be provided both in the handle and on the door below the handle. The IR LED, photo-detector and signal processor circuitry, mounted on the PCB, function to detect an interruption of the beam by a user and provide a control signal to the control module in the same manner as the sensor of the previous embodiments. Also, the indicator and back and ground light LEDs in the handle and the indicator LEDs in the sensor are operable by the control module in the same manner as those used in the previous embodiments.

In this embodiment, the cover 423 and optical lens assembly 419 are of circular cross section and cooperate to form the optical enclosure for the sensor 401. An annular sidewall 480 of the optical lens assembly is terminated by a larger diameter transparent dome shaped head 492 and has an array of latching proterbances 485 molded thereon which engage corresponding slots 491 formed in an annular side wall 483 of the cover 423 to retain the optical lens assembly partially nested within the cover. The snap ring 470, which is mounted on the sidewall 480, between the head and the top of the cover sidewall 483, includes latching proterbances 485, in this case three, molded on the lower half of the ring. The snap ring 470 together with the head 492 form a retaining clip for retaining the optical assembly in the door skin aperture 480.

The optical sensor 401 can be assembled on the door skin 404 by first inserting the lower portion of the optical lens assembly 419, with the snap ring 470 mounted thereon, in the door aperture 480 from the exterior side of the door skin such that the latching proterbances 485 snap under and engage beneath the skin 404 and the head 492 is seated above the skin 404 to securely fix the assembly in the aperture. Thereafter, the sensor components can be mounted in the optical lens assembly and the cover 423 can be clipped to the optical assembly by latching the proterbances 485 into the slots 491 to secure the components in the housing.

The optical sensor used in this embodiment has the advantage of being mountable to the door skin 404 without additional parts and in a rapid manner therefore minimizing assembly costs. The sensor is also more flexible in that it can be mounted in an aperture formed in a suitable handle if desired to provide alternative beam configurations, such as for example the beam configurations used in the first and second embodiments, that is, either a beam which is transmitted from one end of the handle to the other or from the handle to the door and back to the handle.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. For example, the skilled man would understand that the passive entry sensor system can be used in a variety of applications other than vehicles, such as buildings, containers and other environments in which access control is necessary.

Also, the one skilled in the art would understand that the sensor and systems of the embodiments described herein could be used without a reflector mounted on the door handle or door whereby reflection of the beam could be caused by a users hand inserted in the handle. Also, the sensor circuitry could be configured to detect the presence of the beam rather than the absence of the beam. Furthermore, the skilled man would understand that the sensor, indicators and other components described herein could be mounted in handles of different configurations to those of the described embodiments.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A passive entry sensor system for use with a keyless access control system, comprising:
a handle for opening a door; and
a sensor comprising an electromagnetic radiation emitter for emitting a beam of electromagnetic radiation and an electromagnetic radiation detector for detecting the electromagnetic radiation beam, wherein said emitter and said detector are arranged in said handle such that, when said handle is attached to the door, said sensor can detect at least a partial modification or interruption of the beam caused by a user actuating the handle to open the door.

2. The system of claim 1, wherein said sensor includes a signal processor located in said handle and coupled to said emitter and said detector for detecting at least a partial modification or interruption of the beam and for providing an output control signal to an access control mechanism for controlling the operation of a locking device.

3. The system of claim 1, including a beam reflector for reflecting the emitted beam, said reflector being spaced from said emitter and said detector such that the detector can detect the reflected emitted beam.

4. The system of claim 3, wherein said sensor is located at or adjacent one end of said handle and wherein said reflector is located at or adjacent an opposing end of said handle and whereby the emitted beam can be transmitted along the length of the handle to the opposing end of the handle and reflected back by the reflector to the sensor.

5. The system of claim 1, wherein said sensor is located between opposing ends of said handle whereby the emitted beam can be transmitted beneath the handle towards the door and can be reflected back to the handle and detected by the detector.

6. The system of claim 1, wherein the sensor includes a back-up switch located in said handle for detecting handle motion, said back-up switch for providing an output control signal to the access control mechanism in response to actuation of the back-up switch by movement of said handle in the event of the sensor failing to detect a user actuating the handle.

7. The system of claim 1, wherein the sensor includes an independent locking switch for locking and unlocking said door, said locking switch protruding from said handle for actuation by a user and being configured to generate an output control signal to the access control mechanism in response to the user actuating the switch.

8. The system of claim 7, including an LED mounted in said sensor for Illuminating said locking switch.

9. The system of claim 1, including at least one light source mounted to the handle for indicating one or more system modes and/or providing backlighting or ground lighting in response to a signal from a control module.

10. The system of claim 9, wherein said light source(s) and said sensor are housed in an optical enclosure, said optical enclosure being insertable into said handle.

11. The system of claim 9, wherein each light source comprises an LED optically coupled to an optical element received in a rear aperture of the handle to provide a backlight.

12. The system of claim 9, wherein each light source comprises an LED optically coupled to an optical element received in a side aperture of the handle to provide a sidelight.

13. The system of claim 9, wherein each light source comprises an LED optically coupled to an optical element received in a front aperture of the handle for indicating one or more system modes.

14. A passive entry sensor system for use with a keyless access system comprising:
at least one light source, said light source being operable by a control module to indicate one or more system modes and/or to provide lighting in the vicinity of the handle; and
a sensor comprising an electromagnetic radiation emitter for emitting a beam of electromagnetic radiation and an electromagnetic radiation detector for detecting the beam of electromagnetic radiation, wherein said emitter and detector are arranged such that, when said handle is attached to the door, said sensor can detect at least a partial modification or interruption of the beam caused by a user actuating the handle to open the door.

15. The system of claim 14, wherein each light source and said sensor are located in the same optical enclosure, said optical enclosure being mountable to the door or handle.

16. The system of claim 14, wherein each light source is located in said handle and comprises an LED optically coupled to an optical element received in an aperture of the handle.

17. A passive entry sensor for use in a keyless access system comprising:
an electromagnetic radiation emitter for transmitting a beam of electromagnetic radiation;
an electromagnetic radiation detector for detecting the electromagnetic radiation beam reflected from a surface;
a lens protector for protecting said emitter and detector; and
a housing for housing said emitter, detector, and lens protector,
wherein said housing is adapted to be mountable directly to the skin of a door beneath a door handle such that said sensor can detect at least a partial modification or interruption of the beam caused by a user actuating the handle to open the door.

18. A sensor as claimed in claim 17, including a retaining clip or latch carried on said housing for retaining said sensor in an aperture defined in the door skin.

19. A sensor as claimed in claim 18, wherein said clip comprises a snap ring mounted on said housing, said snap ring being adapted to be engageable beneath the door skin with an upper portion of said housing seated above the door skin to secure the sensor to the skin.

20. A sensor as claimed in claim 19, including at least one LED located in said housing for illuminating said upper portion to provide an indicator beneath the handle.
